(19) United States
(12) Patent Application Publication
(10) Pub. No.: US 2023/0306329 A1
(43) Pub. Date: Sep. 28, 2023

(54) SYSTEM AND METHOD FOR MONITORING AND ANALYSIS OF ELECTRONIC RESOURCE UTILIZATION

(71) Applicant: BANK OF AMERICA CORPORATION, Charlotte, NC (US)

(72) Inventors: George Anthony Albero, Charlotte, NC (US); Olga Caroline Kocharyan, Matthews, NC (US)

(73) Assignee: BANK OF AMERICA CORPORATION, Charlotte, NC (US)

(21) Appl. No.: 17/701,120

(22) Filed: Mar. 22, 2022

(51) Int. Cl. G06Q 10/06; G06F 11/34; G06F 9/451

(52) U.S. Cl. CPC G06Q 10/063118; G06Q 10/06393; G06F 11/3438; G06F 9/451

(57) ABSTRACT

Embodiments of the invention are directed to a system, method, or computer program product for an approach to monitoring and analysis of electronic resource utilization. The system electronically receives interactions from a computer program and uses a classification model to predict an entity project associated with terms extracted from the interaction. Interaction frequency is monitored throughout interactions, and along with the terms, the system determines the amount of time and resources spent for the predicted project. A notification may be provided to one or more user devices in response to this determination, based on an entity need for a project to remain on schedule with an appropriate number of resources.

### BACKGROUND

Currently, projects executed within an entity are assigned to a project manager, whereafter the project manager is responsible for ensuring that tasks related to the project are carried-out by the appropriate resource, within the appropriate timeframe, and that task data are not duplicated by resources. Generally, the amount of time spent on each task data within a project is a self-reported endeavor by the resource, where the resource monitors the time spent on a task data, and that time is entered into the project statistics and held as factual. However, inaccurate time reporting, miscommunication between the project manager and the resources can often lead to undesirable situations where task data are duplicated by multiple resources, the time spent on the task data or project as a whole is inaccurate, and so forth. As such, there exists a need for a system and method for monitoring and analysis of electronic resource utilization.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for monitoring and analysis of electronic resource utilization.

Currently, project managers within entities are responsible for analyzing a project, determining the task data being actively worked on, the status of the task data, the resources who are assigned to work on the task data, and the like. The system and method described herein solve a long-standing problem of project managers relying on self-reporting of time data by resources, which often leads to imperfect measurement of project costs, timing, unbalanced workloads, duplication of efforts on any given task data, and so forth.

The system and method for monitoring and analysis of electronic resource utilization adopts a computer-implemented machine learning platform into a computer-implemented monitoring system which receives, electronically, an interaction between a user and a computer program, such as to begin monitoring the activity of a user. This can occur either by the user viewing a computer program, interacting within the computer program, or typing within the computer program. After this point, the system then electronically monitors the elements of the interaction, such as the terms entered by the user from a keyboard, or interaction metrics such as the frequency at which a user types or clicks throughout the graphical user interface, and so forth. The system uses machine learning via a machine learning platform to electronically predict, using a classification model, a predicted project associated with the terms. In other words, the system takes data seen, input, or interacted with by the user and the system decides/predicts as to which project the user is currently working on. In this way, time spent associated with the project by the user may be captured, as well as level of attentiveness, or the like. The terms may be received from a keylogger which monitors and records keystrokes of the user, or it may be received by interpreting terms from text which is displayed on the screen. Alternatively, or in combination with these methods, it may also be received directly from integrated programs which the system has permissions from the integrated programs to receive data such as text in the integrated program, for example an email, calendar invite, or the like. The system may also receive movement frequency information from the user's cursor on the graphical user interface.

The system may be integrated with a project management software, such that the system received detailed information from the project management software like a work breakdown structure for a project, with individual task data presented to the system for evaluation and comparison between the estimated and actual time spend per task data and estimated and actual resource spend per task data. In this way, a project manager, along with the system or separate from the system, may be able to view situations where overallocation of resources has occurred, or where task data has been duplicated, etc. The system may also be configured to present notifications to users, such that when a project is predicted to which a user is working and no additional resources are required on the project, the notification alerts the user indicating as such. The notification may also indicate this to the project manager, and the notification to either the user or the project manager may have varying levels of escalation, such that it may also interfere with or prevent the user from using certain programs if the determination is such that the user is not required for the task data. The system may also be configured to notify a user or project manager with an assertion that project deadlines may not be met unless additional time or resources are placed on the project.

Embodiments of the invention are directed to a system, method, or computer program product for monitoring and analysis of electronic resource utilization, the invention comprising electronically receiving as an input to the system an interaction between a user and a computer program, wherein the interaction comprises at least one of: viewing the computer program, interacting within the computer program, and typing within the computer program, recording a date and time as a result of the interaction, wherein recording the date and the time is continuous, and recording ends when the interaction ends, electronically monitoring the interaction elements of the interaction, wherein the interaction elements comprise terms associated with the interaction and interaction metrics, and wherein electronically monitoring the interaction elements is continuous, and electronic monitoring ends when the interaction ends, and electronically predicting, using a classification model, a predicted project associated with the terms associated with the interaction.

In some embodiments, or in combination with the previous embodiment, the system, method, or computer program product further comprises receiving terms from a keylogger, wherein the keylogger records entered keystrokes entered by a user on a keyboard, and wherein the keylogger parses terms from the entered keystrokes, receiving terms from displayed text on a graphical user interface of a user device, wherein the displayed text on the graphical user interface is transformed by text data mining, receiving terms from integrated programs, wherein the integrated programs are configured to export data associated with the integrated programs, and receiving movement frequency from a cursor on the graphical user interface.

In some embodiments, or in combination with any of the previous embodiments, receiving as an input a plurality of project data, wherein each project data comprises a work breakdown structure comprising a plurality of task data, wherein each of the plurality of task data comprises a task resource estimate and a task time estimate, calculating a project resource estimate and project time estimate for a project based on the task data, aggregating a time spend for each resource and a resource spend, the resource spend comprising the time spend for each resource, and compare the project resource estimate to the resource spend, and compare the project time estimate to the time spend, and notifying the user of underestimates or overestimates for the time spend and/or the resource spend.

In some embodiments, or in combination with any of the previous embodiments, the system is configured to notify the user by displaying a notification on the graphical user interface when the predicted project associated with the terms does not require additional time spend by the user.

In some embodiments, or in combination with any of the previous embodiments, the interaction elements further comprise a frequency rating, wherein the frequency rating is labeled as either high, medium, or low, and the frequency rating is determined by the frequency of interaction between the user and at least one of: the cursor and the keyboard.

In some embodiments, or in combination with any of the previous embodiments, the classification model is taught using terms from a project document.

In some embodiments, or in combination with any of the previous embodiments, the notification comprises one notification corresponding to a range of notifications, wherein the range of notifications comprises notifications with a varying level of escalation.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a network environment in which the processes described herein are implemented, in accordance with some embodiments of the present invention;

FIG. 2 illustrates a block diagram of a method for electronically predicting a project using a classification model within a system for monitoring and analysis of electronic resource utilization, in accordance with some embodiments of the present invention;

FIG. 3 illustrates a block diagram of a method for receiving inputs from a user for a system and method for monitoring and analysis of electronic resource utilization, in accordance with some embodiments of the present invention;

FIG. 4 illustrates a block diagram of a system and method for performing an assessment of time spend and resource spend for a project, in accordance with some embodiments of the invention; and

FIG. 5 illustrates a simplified graphical representation of a notification system within a system for monitoring and analysis of electronic resource utilization, in accordance with some embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Embodiments of the invention are directed to a system, method, or computer program product for an approach to monitoring and analysis of electronic resource utilization. The system electronically receives interactions from a computer program and uses a classification model to predict an entity project associated with terms extracted from the interaction. Interaction frequency is monitored throughout interactions, and along with the terms, the system determines the amount of time and resources spent for the predicted project. A notification may be provided to one or more user devices in response to this determination, based on an entity need for a project to remain on schedule with an appropriate number of resources.

In accordance with embodiments of the invention, the term “entity” may be used to include any organization or collection of users that may interact with a network. An entity may refer to a business, company, or other organization that either maintains or operates the system or requests use and accesses the system. “Entity” may be used to include any organization that supports, executes, or otherwise is involved in projects of any type. For example, an entity may be any institution with projects related to any number of information technology projects, real estate development, logistics, product development, or the like. In other words, the entities to which the system and method may apply are limitless, so long as the entity has a project which involves the use of resources, and of which the entity wishes to track the resources and their task data in an effort to deliver the project on a desired timeline.

A “user” as used herein may refer to any entity or individual associated with the system. In some embodiments, a user may be a computing device user, a phone user, a mobile device application user, a financial institution customer (e.g., an account holder or a person who has an account (e.g., banking account, credit account, or the like)), a system operator, database manager, a support technician, and/or employee of an entity. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, laptop computers, cameras, video recorders, audio/video player, radio, global positioning system (GPS) devices, or any combination of the aforementioned. In some embodiments, a device may refer to an entity's computer system, platform, servers, databases, networked devices, or the like. The device may be used by the user to access the system directly or through an application, online portal, internet browser, virtual private network, or other connection channel. The device may be a computer device within a network of connected computer devices that share one or more network storage locations.

As used herein, the term “resource monitoring platform” may refer to any software or software-implemented system which is configured to perform the data mining and capturing of data related to the interactions with a user device performed by a user. The resource monitoring platform may collect data from a user device, including the keyboard, mouse, and graphical user interface of a user device, and also the integrated programs utilized on the user device, in order to aggregate the data in an effort to electronically predict which project a user is currently working on. The resource monitoring platform may be connected with a software program installed on a user device, and configured to work alongside various applications, and in some cases using the graphical user interface (“GUI”) of a user device. The resource monitoring platform may be configured with a keylogger, screen recorder or capture device, or various integration mechanisms for integration with native programs of a user device, such that the interactions between a user device and a user can be quantified, parsed for data such as terms or number of interactions, or the like. The resource monitoring platform may be configured to run seamlessly in the background of a user device, such that the user device functionality is not impaired by the presence of the resource monitoring platform. In some embodiments, the resource monitoring platform may be configured to show alerts to a user on the graphical user interface of a device. In other embodiments, a user may not be aware that the resource monitoring platform is currently configured to execute actions on the user device and is running in the background of the user device. In yet additional embodiments, the resource monitoring platform may comprise a user interface itself, such that the program allows a user to view the inputs and outputs to the user device, or even a graphical display of time spend and/or resource spend allowances for any work data associated with a project. In this way, the user has a clear visual indication of the amount of time spend for work data, and how much time and/or resources are allotted for the remainder of the work data.

As used herein, the term “classification model” may refer to a machine learning classification technique or clustering algorithm which uses an algorithm to receive input data and parameters to determine an output/prediction of classification, such as K-Nearest Neighbors (“K-NN”) artificial neural networks, K-means algorithms, decision trees, Naïve Bayes algorithms, support-vector machines, regression analysis, training models, Bayesian networks, federated learning, or the like. As one non-limiting example of a classification model using a K-NN approach, the classification model may make decisions or predictions without the need of being discretely programmed to make decisions or predictions. Data objects are received and classified or “clustered” into a class membership based on the nearest neighbors within a number k of neighbors. For example, if k=3, a present data object is plotted along a graph, and the algorithm determines which 3 other data objects are closest in relation to the present data object. In some instances, the 3 surrounding data objects are given weights associated with their location and distance from the present data object (e.g. the nearest data object to the present data object may be provided a higher weigh than the other two data objects). In this way, the system uses classifications of “neighbor” data objects to reasonably predict the classification of the present data object. The k variable may be any number of integers, and in some cases the value of k may be such that it increases or decreases depending on the confidence level determined by the output of the classification model. As will be understood to one with ordinary skill in the art, classification models of various types (as previously listed) may be implemented in place of the K-NN type model, with varying methods and mathematical calculations performed in order to classify raw data. The input to the classification model may be such that the classification model improves over time. For example, the classification model may implement numerous approaches such as supervised learning, unsupervised learning, reinforcement learning, or the like, in order to convert mined data into the machine learning algorithm. The classification model may also be initially “trained” to recognize certain classifications (for example, projects in this case) by providing the classification model with data to train the model. In this way, the classification model has a starting point to which it will begin to classify terms.

As used herein, the term “machine learning platform” may refer to any software or software-implemented method which is configured to train, build, and deploy classification models, machine learning models, algorithms, and/or machine learning operations (“MLOps”). The machine learning platform may generate classification models, machine learning models, orchestrate and deploy machine learning and/or classification models, and also conduct health, diagnostic, and/or metrics calculations to reduce problems associated with ongoing use of machine learning in an entity.

As used herein, the term “resource” may refer to a person, employee, group of people, vendor, or the like, who is responsible for spending time on any part of a project in order to provide a deliverable in support of the project. For some work packages or “work data”, there may be multiple resources involved in the work required to fulfill the task. In other work data, only one resource may be involved.

As used herein, the term “work data” may refer to a discrete sub-portion of a project, the work data being typically a finite task or deliverable with a known group of stakeholders and resources. In order for a project to be considered complete, all of the work data within a project must also be completed. For example, an overall project may be “building a house,” whereas individual work data within the project may be “painting the walls,” “installing the roof,” and so forth. For any given project, the project is typically divided up into individual work data such that a project manager or other stakeholder is able to hold smaller groups of resources accountable to their timelines, budgets, resource allocations, or the like.

As used herein, the term “text data mining” may refer to a process implemented by the resource monitoring platform as one method of retrieving terms used, types, or viewed by a user on the user device. Text data mining involves automatic extraction of information from written documents, programs, or the like. In some embodiments, a statistical pattern learning method is implemented, wherein trends and patterns are determined in the text and the patterns are used in assisting the extraction. In some embodiments, various techniques are applied to the text, either before, during, or after the mining, such as dimensionality reduction to identify root words, natural language processing (“NLP”), syntactic parsing, sentiment analysis, quantitative text analysis, tokenization, filtering, etc. In some embodiments, text data mining may also comprise optical character recognition (“OCR”) such that images, videos, papers, pdfs, or other types of visual mediums on which text may be integrated with or displayed on are able to be electronically converted to machine-encoded text for later processing, filtering, categorization, or use within the classification model. In this way, if a user is viewing a photograph on the user device which is simply a photo of text and text is not ascertainable as machine-encoded, the OCR functionality will allow the system to determine the text and convert it into machine-encoded text format.

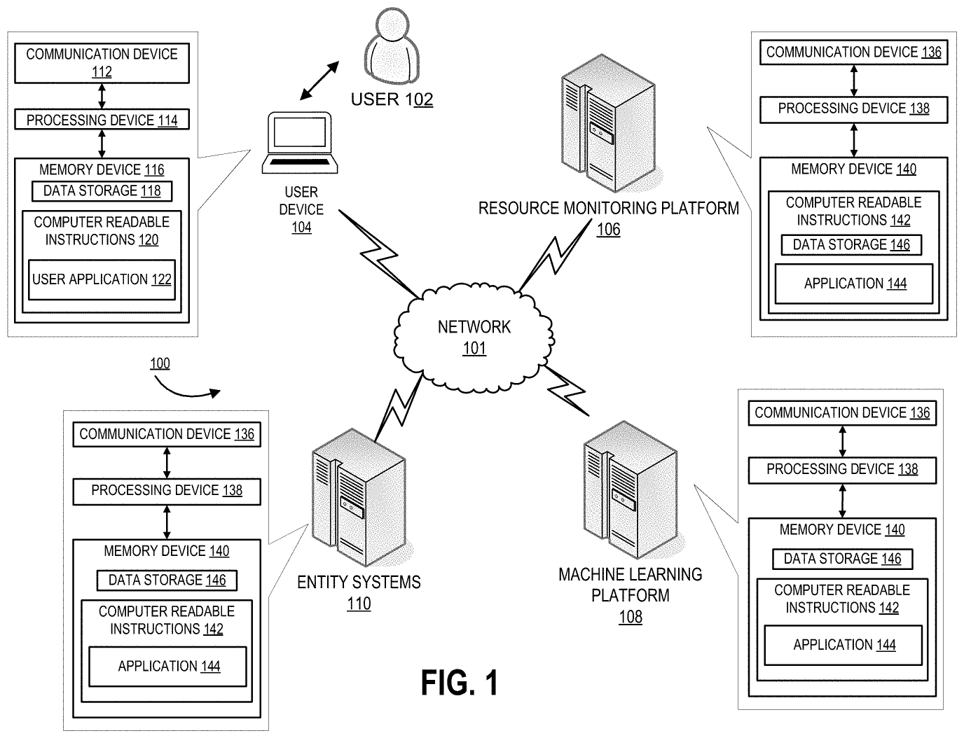

FIG. 1 illustrates a system that includes specialized systems and devices communicably linked across a network to perform a method for monitoring and analysis of electronic resource utilization. FIG. 1 provides an environment 100 for the system, in accordance with one embodiment of the present invention.

As illustrated in FIG. 1, the entity systems 110 is operatively coupled, via a network 101 to the user device 104, and to the resource monitoring platform 106, and machine learning platform 108. In this way, entity systems 110 can send information to and receive information from the user device 104, resource monitoring platform 106, and machine learning platform 108. It shall be noted that in some embodiments of the invention, resource monitoring platform 106 and machine learning platform 108 are merely systems along entity systems 110, and as such entity systems 110 may comprise resource monitoring platform 106, and machine learning platform 108. FIG. 1 illustrates only one example of the system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network.

In some embodiments, the user 102 is an individual associated with an entity who has the ability and/or authority to access entity systems 110, resource monitoring platform 106, machine learning platform 108, or the like. Those skilled in the art will appreciate that at least some example embodiments contemplate multiple such users. In some embodiments, the user 102 has a user device, such as a mobile phone, tabled, computer or the like. FIG. 1 also illustrates a user device 104. The user device 104 may be any communication device such as a smart phone, a telephone, a tablet, a computer, or the like, but is preferably a computing device or terminal. User device 104 can perform computing functions, and the device may be used by the user to access the system and/or network 101 directly or through an application, online portal, internet browser, virtual private network, or other connection channel. The device may be a computer device within a network of connected computer devices that share one or more network storage locations.

The user device 104 generally comprises a communication device 112, a processing device 114, and a memory device 116. The processing device 114 is operatively coupled to the communication device 112 and the memory device 116. The processing device 114 uses the communication device 112 to communicate with the network 101 and other devices on the network 101, such as, but not limited to the entity systems 110, resource monitoring platform 106, and machine learning platform 108. As such, the communication device 112 generally comprises a modem, server, or other device for communicating with other devices on the network 101.

As further illustrated in FIG. 1, the user device 104 comprises computer-readable instructions 120 stored in the memory device 116, which in one embodiment includes the computer-readable instructions 120 of a user application 122 and data storage 118. A user device 104 is preferably a personal computing device or terminal, but it may be any communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, voice assistants, laptop computers, cameras, video recorders, audio/video player, radio, GPS devices, any combination of the aforementioned, or the like. Although only one user device 104 is depicted in FIG. 1, the system environment 100 may comprise a plurality of user devices 104. In some embodiments of the invention described herein, a plurality of user devices 104 is used. In other embodiments, user devices 104 are not necessary for the functionality of the system and may not be integrated into the system in any appreciable manner.

As illustrated in FIG. 1, the entity systems 110 generally comprises a communication device 136, a processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the resource monitoring platform 106, machine learning platform 108, and the user device 104. As such, the communication device 136 generally comprises a modem, server, or other device for communicating with other devices on the network 101.

As further illustrated in FIG. 1, the entity systems 110 comprises computer-readable instructions 142 stored in the memory device 140, which in one embodiment includes the computer-readable instructions 142 of an application 144. In some embodiments, memory device 140 includes data storage 146 for storing data related to the system environment, but not limited to data created and/or used by the application 144.

Embodiments of the entity systems 110 may include multiple systems, servers, computers or the like maintained by one or many entities. FIG. 1 merely illustrates one of those systems. In one embodiment of the invention, the entity systems 110 is operated by a second entity that is a different or separate entity from the resource monitoring platform 106, and machine learning platform 108. In some embodiments, the resource monitoring platform 106 and machine learning platform 108 may be part of the entity systems 110. Similarly, in some embodiments, the entity systems 110 is part of the resource monitoring platform 106 and machine learning platform 108.

In one non-limiting example of the entity systems 110 the memory device 140 stores an application 144. In one embodiment of the invention, the application 144 may comprise computer executable program code that instructs the processing device 138 to operate the communication device 136 to perform certain communication functions described herein. In one embodiment, the computer-executable program code of an application associated with the network and application 144 may also instruct the processing device 138 to perform certain logic, data processing, and data storage functions of the application.

The processing device 138 is configured to use the communication device 136 to gather data, such as data corresponding to data flows, data flow steps, inputs from a user in terms of interdependency of each data flow step, key output metrics defined by a user, characteristics of data flow steps such as current cycle time, touch time, rework time, wait time, or the like. The processing device 138 stores the data that it receives in its memory device 140.

Resource monitoring platform 106 and machine learning platform 108 are each operatively coupled to entity systems 110, user device 104, and/or each other through network 101. Resource monitoring platform 106 and machine learning platform 108 have systems with devices the same or similar to devices described for entity systems 110 and/or user device 104 (i.e., communication device, processing device, memory device). Therefore, resource monitoring platform 106 and machine learning platform 108 communicate with each other, and/or with user device 104, and/or with entity systems 110 in the same or similar way as previously described with respect to each system.

As such, resource monitoring platform 106 and machine learning platform 108 each generally comprise a communication device, at least one processing device, and a memory device. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device is operatively coupled to the communication device and the memory device. The processing device uses the communication device to communicate with the network 101 and other devices on the network 101. As such, the communication device generally comprises a modem, server, wireless transmitters or other devices for communicating with devices on the network 101. The memory device typically comprises a non-transitory computer readable storage medium, comprising computer readable/executable instructions/code, such as the computer-readable instructions, as described below.

As further illustrated in FIG. 1, resource monitoring platform 106 and machine learning platform 108 each comprise computer-readable instructions or computer readable program code stored in the memory device. The computer readable instructions, when executed by the processing device 138 are configured to cause the processing device to perform one or more steps described in this disclosure.

It is understood that the servers, systems, and devices described herein illustrate one embodiment of the invention. It is further understood that one or more of the servers, systems, and devices can be combined in other embodiments and still function in the same or similar way as the embodiments described herein.

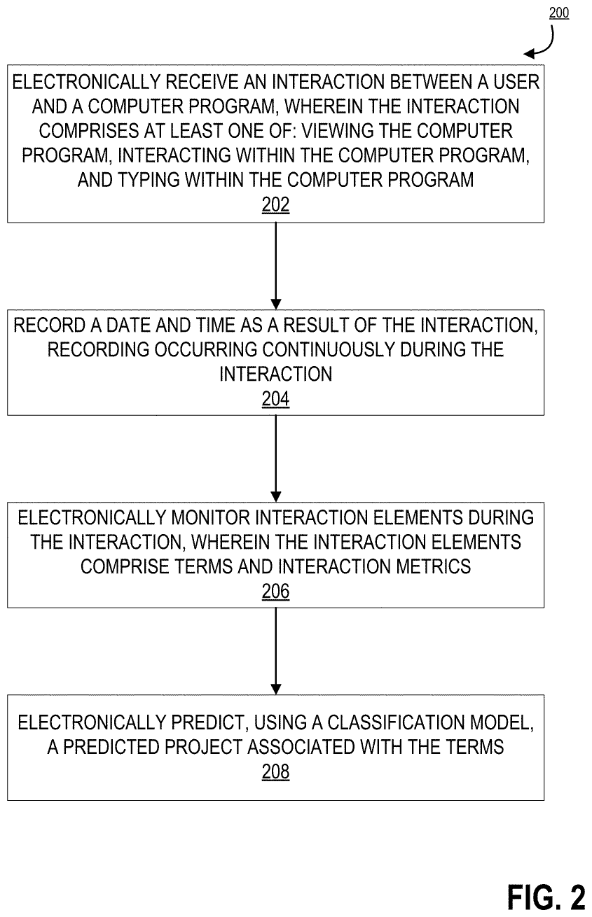

FIG. 2 illustrates a block diagram 200 of a method for electronically predicting a project using a classification model within a system for monitoring and analysis of electronic resource utilization, in accordance with some embodiments of the present invention. As illustrated in block 202, the system electronically receives an interaction between a user and a computer program, wherein the interaction comprises at least one of: viewing the computer program, interacting within the computer program, and typing within the computer program. The system as described herein is configured to integrate into a user device, and thereafter be capable of monitoring interactions of a user within said user device. It shall be appreciated that the system may be inactive for extended periods of time, such as times when the user device is not in use, or not receiving power, or in some embodiments the system may only be configured to be active (e.g. receiving interactions) between certain hours, such as pre-determined work hours on specific days. In instances where the system is configured to only activate and monitor interaction elements during certain times or after certain interaction with specific computer programs, the system is initiated by actions occurring between the user and a computer program. The computer program could be any number of specific programs, or in some embodiments the computer program may be a selected computer program from an array of computer programs determined by the entity. To initiate the process, a user interacts with the user device in this way, and as such the system receives the interaction. This may occur as a result of the user viewing a computer program on the user device, or in some embodiments the receiving of interactions may occur as a result of a user interacting with a cursor via a computer mouse, or typing via a computer keyboard within the computer program.

The process continues as illustrated in block 204, by recording a date and a time as a result of the interaction. As previously mentioned, the ultimate purpose of the system is to determine the resource(s) and amount of time spent by said resource(s) on any given project. As such the system records a date and time at which the user is interacting with a computer program as a starting point for what the system will use to calculate the amount of time spent on any given project, once the system has predicted the project being worked on by the user, as will be discussed later herein. The system may also be configured to record times for any given event during the interaction, such that the system continuously records times. For example, a user may close a computer program and then subsequently open a different program. The system is configured to record the date and time for this occurrence, in one aspect because the user may be switching the project to which the user is working, and as such in order for the system to accurately calculate the amount of time spent on any project, these continuous recordings serve as markers or indications of where a project may have changed. In this way, as will be discussed herein, the system may end the time calculation (e.g., the time collection) for the first project and thereafter begin the recording of time (for use in a subsequent time calculation) for the second project. The system will continuously record dates and times either at a pre-determined frequency, or a frequency as a result of the nature of the interactions themselves.

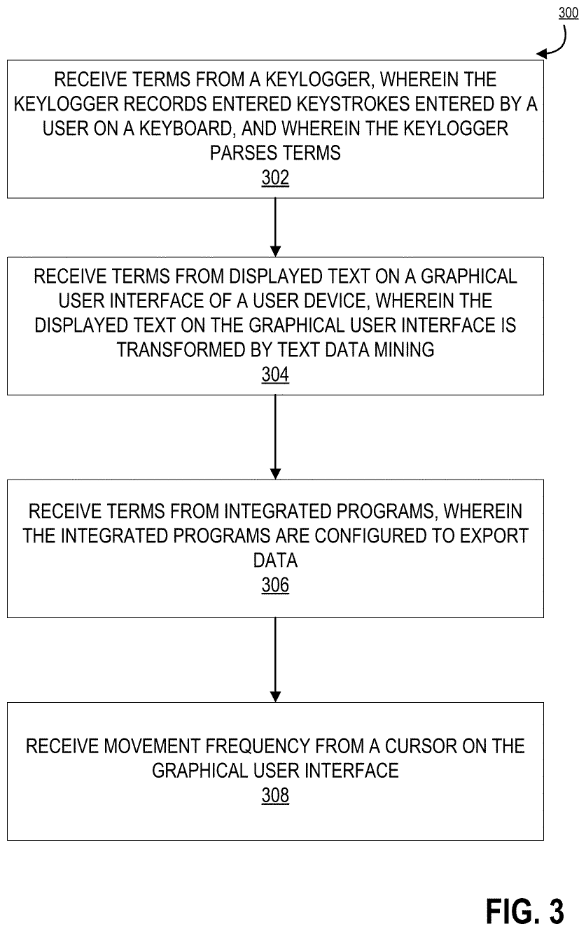

In block 206, the process continues by electronically monitoring interaction elements during the interaction, wherein the interaction elements comprise terms and interaction metrics. Once an interaction has been determined to be occurring, and electronically received by the system as previously noted in block 202, the system then is configured to electronically monitor interaction elements which occur during the interaction. These interaction elements may be numerous, such that the system must constantly monitor inputs from a user, or outputs from the user device, graphical user interface, and the like. Various types and methods of terms extraction methods will be discussed herein in FIG. 3.

In addition to the terms, the interaction elements may also comprise interaction metrics. Interaction metrics are any number of ways to calculate or determine the amount of attention a user is paying to a particular computer program. For example, while although a user may interact through a computer program, the user may be inattentive to the program while working mostly in a separate program, having a conversation with other users, or the like. In this way, the system is configured to classify the interaction metrics with a frequency rating (e.g. the frequency of interaction). This frequency rating may be determined to be high, medium, or low, or in some embodiments a number on a scale, for example a scale between one and ten (e.g. 1-10) may indicate the frequency rating. In some embodiments, the frequency rating may be used by the system to assign respective weights to interactions between the user and the computer program. For example, an interaction with a low frequency rating may be given a low weight, and therefore the amount of progress on the project for which the interaction has been predicted to be associated with is less than that of a high weight for a high frequency interaction. In this way the system may then be able to give less merit to the amount of time spent during the interaction.

In block 208, the system electronically predicts, using a classification model, a predicted project associated with the terms. The system electronically receives the terms using the various techniques as described herein, for example as text input by a user using a keyboard, the text obtained by a keylogger. Or in other embodiments, a text mining technique or optical character recognition may occur which converts graphical text symbols displayed on a screen into text using natural language libraries. In other embodiments, text may be extracted from integrated computer programs themselves, such as word processing programs, email programs, instant messengers, and so forth. The terms, received from any of these sources, are then supplied to the classification model in the machine learning platform to electronically predict the project to which the terms most likely belong.

The classification model, like many machine learning algorithms, may be trained or “taught” by supervised learning technique or unsupervised learning techniques. The initial training dataset provided to the classification model is derived from project documents in the entity system, for example the project charter, which is a document created at the onset of a project which outlines project deliverables, stakeholders, project timelines and milestones, as well as provides market segments to be addressed by the project, etc. As such, the project charter is a document containing terms which are unique to the project, such as descriptive terms, names of individuals associated with the project, and so forth. The classification model will use these terms derived from the project charter to make an initial prediction as to the which project is associated with the terms found during the interaction. Thereafter, supervised learning may be used wherein the output of the classification model is reviewed and/or modified by a user associated with the entity such as a project manager, allowing the project manager to make corrections to the predicted project determined by the classification model, and as such the classification model's predictions become more accurate over time. In some embodiments, the classification model may use unsupervised learning to implement an iterative process to improve accuracy based on the correlation to the expected patterns or clusters in the classification model.

FIG. 3 illustrates a block diagram 300 of a method for receiving inputs from a user for a system and method for monitoring and analysis of electronic resource utilization, in accordance with some embodiments of the present invention. The process begins in block 302 by receiving terms from a keylogger, wherein the keylogger records the keystrokes entered by a user into a keyboard, and wherein the keylogger parses terms thereof. In some embodiments, the system may monitor and record inputs from the user to a keyboard of the user device, either a physical keyboard or a touchpad keyboard, using a keylogger. The keylogger is configured to record each keypress of the keyboard of the user device during interaction with the user, and in this way the words, phrases, sentences, and so forth which are input by the user are captured by the system. The system may then implement natural language tools to parse the text, if not parsed already, to select words and phrases, eliminate unnecessary “filler” or repetitive words, such that terms are extracted efficiently. For example, the phrase “We will build a house” may be parsed to simply be two terms: “build” and “house”.

Block 304 continues the process by receiving terms from text which is displayed on a graphical user interface (“GUI”) of the user device, wherein the displayed text on the GUI is transformed by text data mining. Text data mining, as previously described, is capable of transforming a graphic containing text, such as an image, video, or the like, and determining which text is within the graphic for potential use as a term. In this way, any graphical object, pdf, video, or graphic rendering which contains text viewed by the user on the user device can be transformed into manipulable text, and where terms can be derived from. In some embodiments, the text data mining may occur at the same time as viewed by the user on the GUI. In other embodiments, the system may capture screenshots of various images for subjection to the text data mining at a different time or location.

Block 306 continues by receiving terms from integrated programs, wherein the integrated programs are configured to export data, such as the text, to the system. In some embodiments, the system may obtain appropriate permissions by various programs on a user device, such as a word processing program, spreadsheet program, email exchange program, or the like. In this way, text which is viewed or entered within each of these integrated programs can be extracted by the system for evaluation without the requirement of using a keylogger or a text data mining system. The integrated programs will export any text interacted with by the user at a given time and allow the system to parse the text and extract terms therefrom. In situations where a computer program has not granted permission to the system to receive such data, the system may ultimately resort to other means of collecting information, such as utilizing the keylogger or using text data mining.

In block 308, the system receives movement frequency from a cursor on the graphical user interface. In this way, the system will receive input from the user defining the amount of cursor (or “mouse”) movements input into the user device. This data will be provided to the system to help define the interaction metrics as outlined in block 206. For example, the system may receive that a user moved their cursor on average once every minute, and therefore the interaction metrics may suggest that the frequency rating is categorized as low. Alternatively, the user may move the cursor on average thirty times per minute, and therefore the interaction metrics may suggest that the frequency rating is categorized as high.

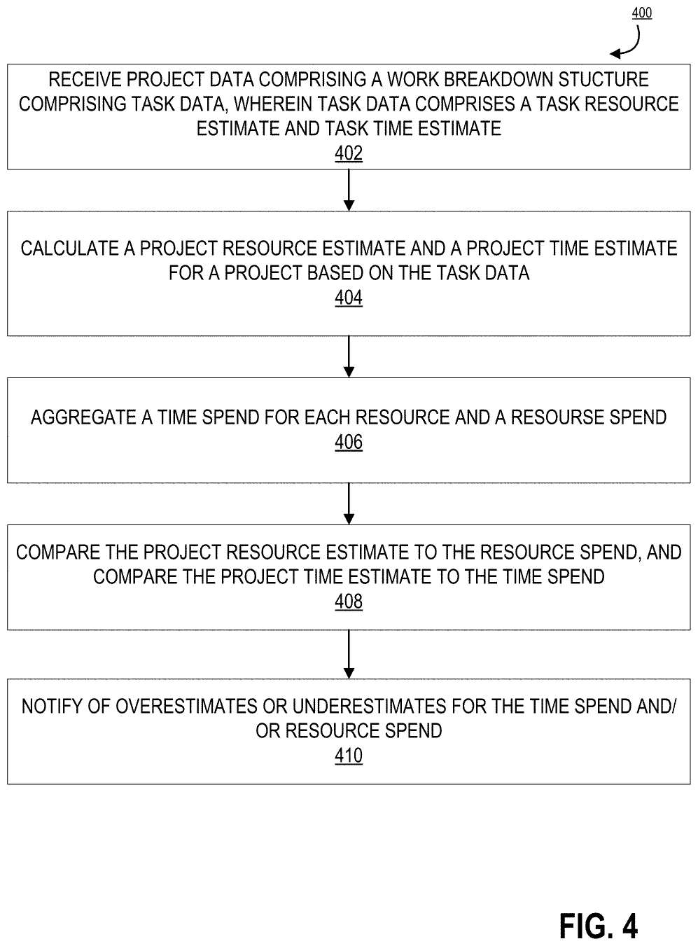

FIG. 4 illustrates a block diagram 400 of a system and method for performing an assessment of time spend and resource spend for a project, in accordance with some embodiments of the invention. The process begins in block 402, where the system receives project data comprising a work breakdown structure comprising task data, wherein the task data comprising a task resource estimate and a task time estimate. It shall be appreciated that any project for which this system may be implemented, the project is comprised of multiple task data required in order to complete the project. For example, for a project related to building a house, the project is comprised of task data such as “pour the foundation”, “build the frame”, and the like. Each of these individual task data usually has a specific set of users assigned to carry out each of the task data, along with separate target completion dates, start dates, etc. As such, any given project may be broken-down into task data prior to the project starting, or in some embodiments task data may be determined on a rolling or as-needed basis. The compilation of each of these task data is typically stored in a document known as the work breakdown structure. The work breakdown structure is often managed by a project manager. It is not adequate for a large project to track overall project progress without having such a work breakdown structure in some form or another. The system as described herein may likewise benefit from using such data in determining whether there are too many users on a project or task data, whether the overall schedule is in jeopardy, etc.

The work breakdown structure of a project may be supplied to the system in a number of ways, including but not limited to receiving a file from a project management software, receiving a spreadsheet with said information, etc. Each task data within the work breakdown structure comprises a task resource estimate, which represents the number of full-time users required to carry out the task data. Likewise, each task data within the work breakdown structure may comprise a task time estimate, which represents the number of hours, e.g., total work hours estimated to be required by the task data.

As such, and as illustrated by block 404, after the system receives a work breakdown structure document, the system then calculates a project resource estimate and a project time estimate for the project based on the task data. In some embodiments, the task data supplied to the system has defined number of resources as well as number of hours required. In other embodiments, the system may use historical data from past projects to calculate a mathematical average of similar task data already completed to estimate the project resource estimate and project time estimate. In other embodiments, the system may use this historical data in conjunction with a supplied fixed value for project resources (e.g. if the entity only has a defined number of resources available for the task data) and as such the system will use historical data for calculating the project time estimate based on a similar number of project resources in past projects. Alternatively, in other embodiments the system may use this historical data in conjunction with a supplied fixed value for project time (e.g., if the entity only has a defined amount of time to complete the task data) and as such the system will use historical data for calculating the project resource estimate based on a similar amount of time spent for similar task data in past projects. As such, the project resource estimate and the project time estimate for any given project is provided as an output by the system.

In block 406, over the course of a project in which time and resources are being utilized for completion of said project, the system regularly at certain time intervals (or in some embodiments, constantly, in an ongoing fashion) aggregate the time spend for each resource spend for a given project or multiple projects. For example, User A may have spent six hours during the previous day working on a certain project, as determined by the machine learning of the system. The system will then take User A's six hours and add the hours to a total number of hours that User A has spent on the project. Likewise, a similar function occurs for User B, User C, and so forth. In this way, each of the resources (e.g., Users A, B, and C) has a “time spend” which is the amount of time each resource has spent on the project for a given time period. Likewise, the system will also calculate a “resource spend” which is the number of resources working on a project during a given time.

As illustrated in block 408, the system is then configured to compare a project resource estimate to the resource spend and compare the project time estimate to the time spend. The “project resource estimate” is an aggregation of the task time estimate(s) previously determined in block 402. As noted, an entire project may comprise multiple task data, and as such the task resource estimate for one task data should be combined with task resource estimates for the other task data in order to determine the project resource estimate for the entire project. Similarly, the entire project comprising multiple task data, and as such the task time estimate for one task data should be combined with task time estimates for the other task data in order to determine the project time estimate for the entire project. After the project time estimate and the project resource estimate have been calculated, the system is able to compare the time spend (e.g., the actual time spent for a project up until a given point) to the project time estimate, and similarly compare the resource spend (e.g., the actual number of persons working on a project up until a given point) to the project resource estimate.

It shall be understood that in some embodiments of the present invention, the system may also take task data and perform a similar analysis, such that the task resource estimate and the task time estimate and compared to resource spend and time spend on any given task data. In this way, instead of comparing for the final deadline of the project, the comparison is made for each task data making up the project, and as such may provide beneficial tracking in smaller increments.

Block 410 represents the actions the system takes once the project resource estimate is compared to the resource spend, and the project time estimate is compared to the time spend. It shall be noted that the resource spend and the time spend may be calculated, as previously recited in block 408, to be based on task resource estimate and task time estimate. The system notifies users of any underestimates or overestimates for the time spend and/or resources spend. In this way, the system may provide a notification or alert to a user on the graphical user interface of the user device, either a user defined as a resource on a project, or a project manager, regarding the discrepancy. At this point, the system has predicted, based on the terms entered by the user or viewed on the screen of the user, the project to which the user is working on. The notification may provide information such that it notifies the user that no additional time is needed to be spent on a certain task data. The notification may comprise a varying level of escalation, such that the effect of the notification increases depending on, for example, the number of prior notifications related to a particular project, the underestimate or overestimate of time spend, and so forth. In some embodiments, the notification to the user may lock out or prevent the user from performing any tasks on a given software platform, such that the user is forced to not spend any additional time on a certain task data. Or in some embodiments, it may notify a user that the task data or project as a whole is behind schedule. Similarly, the notification(s) may be provided to a project manager such that the project manager knows the situations when a task data or project is behind schedule or ahead of schedule. In this way, the number of resources may be altered, the project timeline may be altered, or the like.

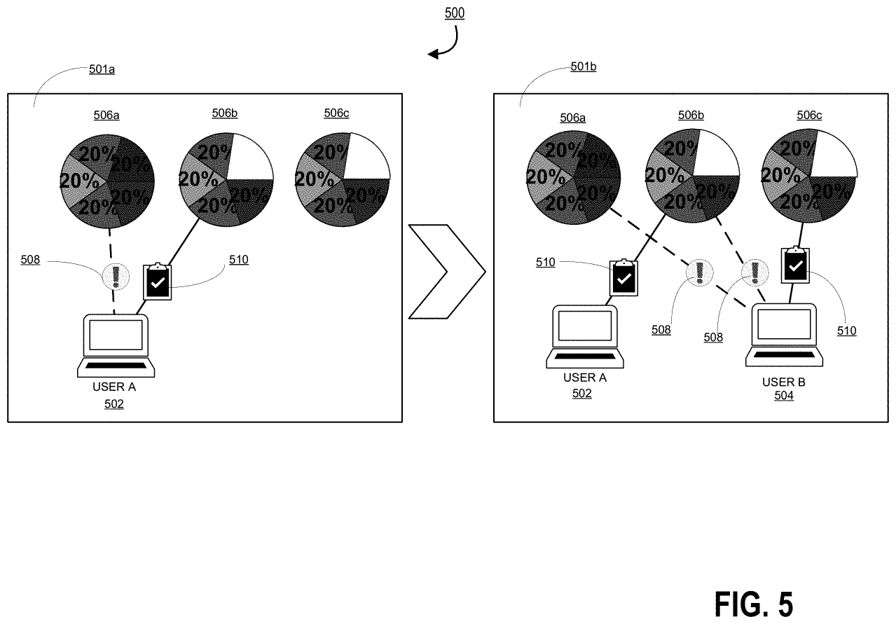

FIG. 5 illustrates a simplified graphical representation 500 of a notification system within a system for monitoring and analysis of electronic resource utilization, in accordance with some embodiments of the invention. Block 501a represents a working environment of a user device 502 belonging to User A. In block 501a, the user device 502 is the only user device in the environment. User A connects to the system through user device 502, and begins to work on a project 506a, as determined to be the predicted project. The system thereafter determines, through the processes previously described, that no additional work is required for project 506a, and thereafter, the system provides a notification 508 to the graphical user interface of user device 502 displaying information such that no additional work is required for the project or the task data within the project. Thereafter, User A decides to work on project 506b, as determined to be the predicted project, and the system determines that additional work is required on project 506b, and thus may send a notification 510 to the user device 502 indicating as such. Although in other embodiments no such notification 510 may be sent to the user device 502.

Block 501b represents a working environment of a user device 502 belonging to User A and user device 504 belonging to User B. In block 501b, the user device 504 has joined the working environment as previously noted in 501a, wherein user device 502 has already began work on project 506b. User B then connects to the system through user device 504, and begins to work on a project 506a, as determined to be the predicted project. The system thereafter determines, through the processes previously described, that no additional work is required for project 506a, and thereafter, the system provides a notification 508 to user device 504 displaying information such that no additional work is required for the project or the task data within the project. Next, User B decides to work on project 506b, as determined to be the predicted project, and the system determines that User A is already working on project 506b, and that only one resource is required for project 506b, thus the system once again provides notification 508 to the graphical user interface of user device 504. Thereafter, User B decides to work on project 506c, as determined to be the predicted project, and the system determines that additional work is required on project 506c, and thus may send a notification 510 to the user device 502 indicating as such. Although in other embodiments no such notification 510 may be sent to the user device 502. It shall be noted that in some embodiments, the system may determine based on the comparison of the project resource estimate, that more than one user may be allowed or needed to work on project 506b, and thus the system may instead allow both User A and User B to work on project 506b simultaneously.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to data flowchart illustrations and/or block diagrams of systems, methods, and/or computer program products. It will be understood that each block included in the data flowchart illustrations and/or block diagrams, and combinations of blocks included in the data flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the data flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the data flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the data flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for monitoring and analysis of electronic resource utilization, the system comprising:
a memory device with computer-readable program code stored thereon;
a communication device;
a processing device operatively coupled to the memory device and the communication device, wherein the processing device is configured to execute the computer-readable program code to:
electronically receive as an input to the system an interaction between a user and a computer program, wherein the interaction comprises at least one of: viewing the computer program, interacting within the computer program, and typing within the computer program;
record a date and time as a result of the interaction, wherein recording the date and the time is continuous, and recording ends when the interaction ends;
electronically monitor interaction elements of the interaction, wherein the interaction elements comprise terms associated with the interaction and interaction metrics, and wherein electronically monitoring the interaction elements is continuous, and electronic monitoring ends when the interaction ends; and
electronically predict, using a classification model, a predicted project associated with the terms associated with the interaction.

2. The system of claim 1, wherein the interaction elements are determined by the processing device configured to execute the computer-readable program code to:
receive terms from a keylogger, wherein the keylogger records entered keystrokes entered by a user on a keyboard, and wherein the keylogger parses terms from the entered keystrokes;
receive terms from displayed text on a graphical user interface of a user device, wherein the displayed text on the graphical user interface is transformed by text data mining;
receive terms from integrated programs, wherein the integrated programs are configured to export data associated with the integrated programs; and
receive movement frequency from a cursor on the graphical user interface.

3. The system of claim 2, wherein the processing device is further configured to execute the computer-readable program code to:
receive as an input a plurality of project data, wherein each project data comprises a work breakdown structure comprising a plurality of task data, wherein each of the plurality of task data comprises a task resource estimate and a task time estimate;
calculate a project resource estimate and project time estimate for a project based on the task data;
aggregate a time spend for each resource and a resource spend, the resource spend comprising the time spend for each resource, and compare the project resource estimate to the resource spend, and compare the project time estimate to the time spend; and
notify the user of underestimates or overestimates for the time spend and/or the resource spend.

4. The system of claim 3, wherein the system is configured to notify the user by displaying a notification on the graphical user interface when the predicted project associated with the terms does not require additional time spend by the user.

5. The system of claim 1, wherein the interaction elements further comprise a frequency rating, wherein the frequency rating is labeled as either high, medium, or low, and the frequency rating is determined by the frequency of interaction between the user and at least one of: the cursor and the keyboard.

6. The system of claim 1, wherein the classification model is taught using terms from a project document.

7. The system of claim 4, wherein the notification comprises one notification corresponding to a range of notifications, wherein the range of notifications comprises notifications with a varying level of escalation.

8. A computer program product for monitoring and analysis of electronic resource utilization, the computer program product comprising at least one non-transitory computer-readable medium having computer-readable program code portions embodied therein, the computer-readable program code portions comprising:
electronically receiving as an input to the system an interaction between a user and a computer program, wherein the interaction comprises at least one of: viewing the computer program, interacting within the computer program, and typing within the computer program;
recording a date and time as a result of the interaction, wherein recording the date and the time is continuous, and recording ends when the interaction ends;
electronically monitoring the interaction elements of the interaction, wherein the interaction elements comprise terms associated with the interaction and interaction metrics, and wherein electronically monitoring the interaction elements is continuous, and electronic monitoring ends when the interaction ends; and
electronically predicting, using a classification model, a predicted project associated with the terms associated with the interaction.

9. The computer program product of claim 8, the computer-readable program code portion further comprising:
receiving terms from a keylogger, wherein the keylogger records entered keystrokes entered by a user on a keyboard, and wherein the keylogger parses terms from the entered keystrokes;
receiving terms from displayed text on a graphical user interface of a user device, wherein the displayed text on the graphical user interface is transformed by text data mining;
receiving terms from integrated programs, wherein the integrated programs are configured to export data associated with the integrated programs; and
receiving movement frequency from a cursor on the graphical user interface.

10. The computer program product of claim 9, wherein performing value assessment of the one or more data flow steps comprises:
receiving as an input a plurality of project data, wherein each project data comprises a work breakdown structure comprising a plurality of task data, wherein each of the plurality of task data comprises a task resource estimate and a task time estimate;
calculating a project resource estimate and project time estimate for a project based on the task data;
aggregating a time spend for each resource and a resource spend, the resource spend comprising the time spend for each resource, and compare the project resource estimate to the resource spend, and compare the project time estimate to the time spend; and
notifying the user of underestimates or overestimates for the time spend and/or the resource spend.

11. The computer program product of claim 10, wherein the system is configured to notify the user by displaying a notification on the graphical user interface when the predicted project associated with the terms does not require additional time spend by the user.

12. The computer program product of claim 8, wherein the interaction elements further comprise a frequency rating, wherein the frequency rating is labeled as either high, medium, or low, and the frequency rating is determined by the frequency of interaction between the user and at least one of: the cursor and the keyboard.

13. The computer program product of claim 8, wherein the classification model is taught using terms from a project document.

14. The computer program product of claim 11, wherein the notification comprises one notification corresponding to a range of notifications, wherein the range of notifications comprises notifications with a varying level of escalation.

15. A computer-implemented method for monitoring and analysis of electronic resource utilization, the method comprising:
electronically receiving as an input to the system an interaction between a user and a computer program, wherein the interaction comprises at least one of: viewing the computer program, interacting within the computer program, and typing within the computer program;
recording a date and time as a result of the interaction, wherein recording the date and the time is continuous, and recording ends when the interaction ends;
electronically monitoring the interaction elements of the interaction, wherein the interaction elements comprise terms associated with the interaction and interaction metrics, and wherein electronically monitoring the interaction elements is continuous, and electronic monitoring ends when the interaction ends; and
electronically predicting, using a classification model, a predicted project associated with the terms associated with the interaction.

16. The computer-implemented method of claim 15, wherein the operations of the computer processing device further comprise:
receiving terms from a keylogger, wherein the keylogger records entered keystrokes entered by a user on a keyboard, and wherein the keylogger parses terms from the entered keystrokes;
receiving terms from displayed text on a graphical user interface of a user device, wherein the displayed text on the graphical user interface is transformed by text data mining;
receiving terms from integrated programs, wherein the integrated programs are configured to export data associated with the integrated programs; and
receiving movement frequency from a cursor on the graphical user interface.

17. The computer-implemented method of claim 16, wherein performing value assessment of the one or more data flow steps comprises:
receiving as an input a plurality of project data, wherein each project data comprises a work breakdown structure comprising a plurality of task data, wherein each of the plurality of task data comprises a task resource estimate and a task time estimate;
calculating a project resource estimate and project time estimate for a project based on the task data;
aggregating a time spend for each resource and a resource spend, the resource spend comprising the time spend for each resource, and compare the project resource estimate to the resource spend, and compare the project time estimate to the time spend; and
notifying the user of underestimates or overestimates for the time spend and/or the resource spend.

18. The computer-implemented method of claim 17, wherein the system is configured to notify the user by displaying a notification on the graphical user interface when the predicted project associated with the terms does not require additional time spend by the user.

19. The computer-implemented method of claim 15, wherein the interaction elements further comprise a frequency rating, wherein the frequency rating is labeled as either high, medium, or low, and the frequency rating is determined by the frequency of interaction between the user and at least one of: the cursor and the keyboard.

20. The computer-implemented method of claim 18, wherein the notification comprises one notification corresponding to a range of notifications, wherein the range of notifications comprises notifications with a varying level of escalation.
